(19) United States
(12) Patent Application Publication
(10) Pub. No.: US 2026/0214489 A1
(43) Pub. Date: Jul. 23, 2026

(54) DITHERING A CHANNEL STATE INFORMATION DATASET FOR TRAINING MACHINE LEARNING BASED MODELS

(71) Applicant: QUALCOMM Incorporated, San Diego, CA (US)

(72) Inventors: Jay Kumar SUNDARARAJAN, San Diego, CA (US); Taesang YOO, San Diego, CA (US); Pavan Kumar VITTHALADEVUNI, San Diego, CA (US); Chenxi HAO, Beijing (CN); Runxin WANG, San Diego, CA (US); Naga BHUSHAN, San Diego, CA (US)

(21) Appl. No.: 19/142,845

(22) PCT Filed: Feb. 27, 2023
(86) PCT No.: PCT/CN2023/078357

§ 371 Date: Jun. 24, 2025

(51) Int. Cl. H04W 24/10; G06N 20/00

(52) U.S. Cl. CPC H04W 24/10; G06N 20/00

(57) ABSTRACT

Certain aspects of the present disclosure provide techniques for preparing datasets for training machine learning based models in wireless communications. An example method for wireless communications performed by a node includes obtaining a dataset; preparing the dataset for training a machine learning (ML) model by applying a data preparation function to entries of the dataset; and providing the prepared dataset for training the ML model.

### INTRODUCTION

Aspects of the present disclosure relate to wireless communications, and more particularly, to techniques for preparing datasets for training machine learning (ML) based models in wireless communications.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a node. The method includes obtaining a dataset; preparing the dataset for training a machine learning (ML) model by applying a data preparation function to entries of the dataset; and providing the prepared dataset for training the ML model.

Another aspect provides an apparatus for wireless communication. The apparatus includes a memory including instructions and a processor coupled to the memory. The processor is configured to: obtain a dataset; prepare the dataset for training a machine learning (ML) model by applying a data preparation function to entries of the dataset; and provide the prepared dataset for training the ML model.

Another aspect provides an apparatus for wireless communication. The apparatus includes means for obtaining a dataset; means for preparing the dataset for training a machine learning (ML) model by applying a data preparation function to entries of the dataset; and means for providing the prepared dataset for training the ML model.

Another aspect provides a non-transitory computer-readable medium having instructions stored thereon for obtaining a dataset; preparing the dataset for training a machine learning (ML) model by applying a data preparation function to entries of the dataset; and providing the prepared dataset for training the ML model.

Another aspect provides a method for wireless communications at a node. The method includes obtaining a dataset and an indication that a dithering function has been applied to the dataset; and training a ML model based on the dataset and the indication.

Another aspect provides an apparatus for wireless communication. The apparatus includes a memory including instructions and a processor coupled to the memory. The processor is configured to: obtain a dataset and an indication that a dithering function has been applied to the dataset; and train a ML model based on the dataset and the indication.

Another aspect provides an apparatus for wireless communication. The apparatus includes means for obtaining a dataset and an indication that a dithering function has been applied to the dataset; and means for training a ML model based on the dataset and the indication.

Another aspect provides a non-transitory computer-readable medium having instructions stored thereon for obtaining a dataset and an indication that a dithering function has been applied to the dataset; and training a ML model based on the dataset and the indication.

Another aspect provides a method for wireless communications at a node. The method includes obtaining a dataset and an indication that a dithering function has not been applied to the dataset; and training a ML model based on the dataset and the indication.

Another aspect provides an apparatus for wireless communication. The apparatus includes a memory including instructions and a processor coupled to the memory. The processor is configured to: obtain a dataset and an indication that a dithering function has not been applied to the dataset; and train a ML model based on the dataset and the indication.

Another aspect provides an apparatus for wireless communication. The apparatus includes means for obtaining a dataset and an indication that a dithering function has not been applied to the dataset; and means for training a ML model based on the dataset and the indication.

Another aspect provides a non-transitory computer-readable medium having instructions stored thereon for obtaining a dataset and an indication that a dithering function has not been applied to the dataset; and training a ML model based on the dataset and the indication.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example machine learning (ML) functional framework for RAN intelligence.

FIG. 6 depicts an example ML model structure and parameter set.

FIG. 7 illustrates an example networked environment in which a channel state information (CSI) compression or reconstruction model is used for determining CSI or a channel estimation.

FIG. 8 depicts an example of a UE and a network entity using trained AI/ML models to convey CSI from the UE to the network entity.

FIGS. 9A and 9B depict example UE-side and network-side AI/ML models.

FIG. 10 depicts an example process flow of a dataset being dithered in preparation for training a ML model.

FIG. 11 is a signaling flow illustrating an example of a UE performing a dithering operation on CSI feedback to create a dithered dataset.

FIG. 12 is a signaling flow illustrating an example of a gNB performing a dithering operation on CSI feedback to create a dithered dataset.

FIG. 13 is a signaling flow illustrating an example of a server performing a dithering operation on CSI feedback to create a dithered dataset.

FIG. 14 depicts a method for wireless communications.

FIG. 15 depicts a method for wireless communications.

FIG. 16 depicts a method for wireless communications.

FIG. 17 depicts aspects of an example communications device.

FIG. 18 depicts aspects of an example communications device.

FIG. 19 depicts aspects of an example communications device.

### DETAILED DESCRIPTION

Aspects of the present disclosure provide apparatuses, methods, processing systems, and computer-readable mediums for preparing datasets for training machine learning (ML) based models in wireless communications.

When training a machine-learning (ML) model, some training datasets can have patterns that cause the machine-learning model to perform poorly, such as causing the ML model to generate outputs that are not as accurate as the outputs from non-ML models. A ML model trained on such a dataset may overfit, which is a potential issue of a ML model in which the ML model generates an algorithm which provides good performance on the training data, but does not predict outcomes correctly for new (e.g., real-world) data. In some aspects, overfitting may also be referred to as the ML model not generalizing. For example, in a ML model for describing the state of a channel (e.g., used for CSI reporting), quantizing of coefficients can cause patterns in a training dataset that lead to the ML model overfitting and being less accurate than non-ML models.

Communications systems may use ML to develop and implement models of wireless channels used in the communications systems. A UE and a network entity (e.g., a gNodeB (gNB)) may use trained ML models to implement functions of a communications system, such as measuring and describing radio-frequency (RF) channels. The ML models may more accurately represent the RF channels than non-ML models, because precision of typical non-ML models is limited by the limited size of codebooks used with those non-ML models, while the precision of ML models is not so limited. The improved accuracy in representing the RF channels may enable the communications system to transmit data more reliably and/or more efficiently (e.g., with lower transmit power and/or taking less time, because the more accurate representation of the RF channels enables the communications systems to use modulation and coding schemes (MCS) that convey data more efficiently, so more data may be transmitted in each period and each transmission is received more reliably, reducing a number of retransmissions the system performs). ML models may also use fewer transmission resources (also referred to as feedback overhead) than non-ML models to convey the channel state information accurately, because the ML models learn to convey the channel state information in a manner that is more efficient than using codebooks and codebook entries, as with non-ML models.

When a UE reports channel state information (CSI) to a network entity, the UE may determine a precoding vector (e.g., a set of coefficients describing a transmit beam from a network entity that the UE determines the UE can best receive), derives coefficients (e.g., a vector of complex numbers including amplitude and phase components) based on projecting the precoding vector to a basis set (e.g., an array describing the channel's spatial domain response, or an array describing the channel's frequency domain response), quantizes (e.g., rounds to a nearest quantization level) the coefficients based on configured parameters (e.g., a quantization level and/or a number of bits to be used in conveying the coefficients), and then conveys the quantized coefficients as a vector of bits in the CSI feedback message. An ML model trained on a dataset including entries that have been quantized, such as CSI reports from UEs, may overfit to the patterns caused by the quantization (e.g., the ML model may output only values corresponding to a quantization level when all of the training data was rounded to that quantization level, as opposed to the ML model outputting values that do not correspond to a quantization level because some of the training data was not rounded to that quantization level) and represent the RF channel less accurately than a non-ML model.

The present disclosure describes techniques for applying a dithering function to entries in a training dataset for an ML model to remove the effect of quantization of the entries. As used herein, “dithering” refers generally to adding noise (e.g., randomly selected small values added to entries) to a dataset to randomize quantization error in the dataset. For example, each of the quantized coefficients in a CSI feedback message may be perturbed (i.e., changed by a small amount) in order to dither the dataset that includes the CSI feedback message.

In aspects of the present disclosure, a UE may quantize entries in a dataset and transmit the entries to a network entity (e.g., a data collection entity or a training entity). The network (e.g., a network entity) may dither the entries before including the entries in a training dataset for a ML model at the same network entity, another network entity, or at a UE.

In some aspects of the present disclosure, the network may configure a UE with a dithering type or mode. Dithering types or modes may include adding a fixed amount to one or more coefficients in a training dataset, adding a random amount to one or more coefficients in a training dataset, adding a first amount to an amplitude and a second amount to a phase for entries consisting of amplitude and phase, etc. The UE may quantize entries in a dataset, then dither (according to the configured dithering type or mode) the entries in a dataset, and then either store the modified dataset locally, transmit the modified dataset to a gNB, transmit the modified dataset to a data collection entity, or transmit the modified dataset to a training entity.

Aspects of the present disclosure may improve performance of ML models by improving training datasets used to train the ML models. The training datasets are improved by reducing patterns in the datasets that can arise from quantization operations performed on data included in the datasets. The removal of those patterns may significantly improve the accuracy of the ML model, which may enable communications systems using such ML models to more accurately represent channels using less feedback overhead, enabling the communications systems to transmit data more accurately and/or more efficiently (e.g., using less power or in a shorter period), because the more accurate representation of the RF channels enables the communications systems to use modulation and coding schemes that convey data more efficiently, so more data may be transmitted in each period (possibly reducing a total number of transmissions) and each transmission is received more reliably, which may reduce a number of retransmissions the system performs.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards, such as future wireless communications technologies, not explicitly mentioned herein.

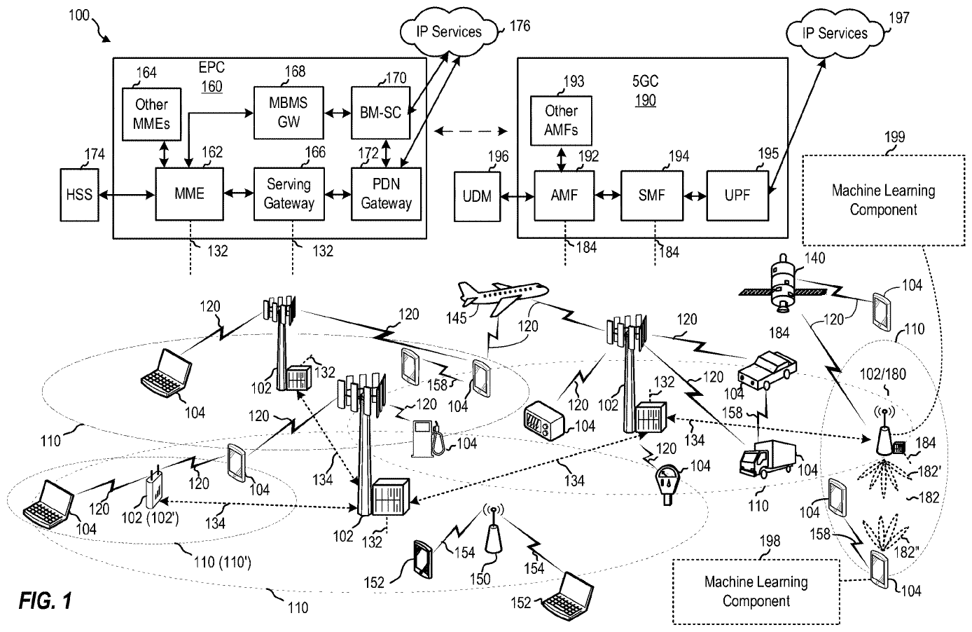

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipment.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

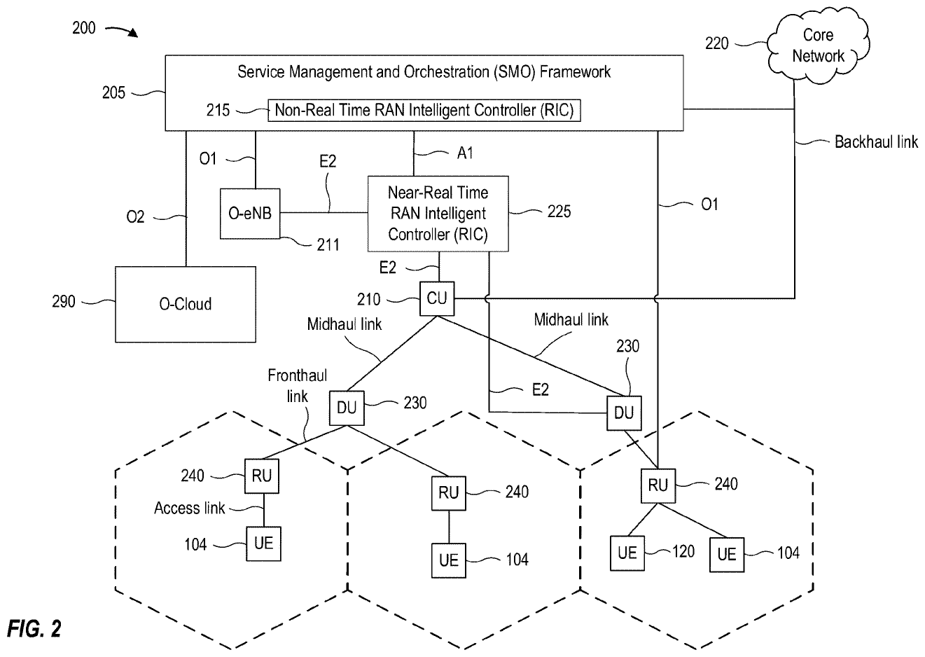

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

Wireless communication network 100 includes a machine learning component 199, which may perform the operations described herein related to machine learning timelines and/or machine learning concurrent processing. Wireless network 100 further includes a machine learning component 198, which may perform the operations described herein related to preparing datasets for use in training ML models.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240, and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

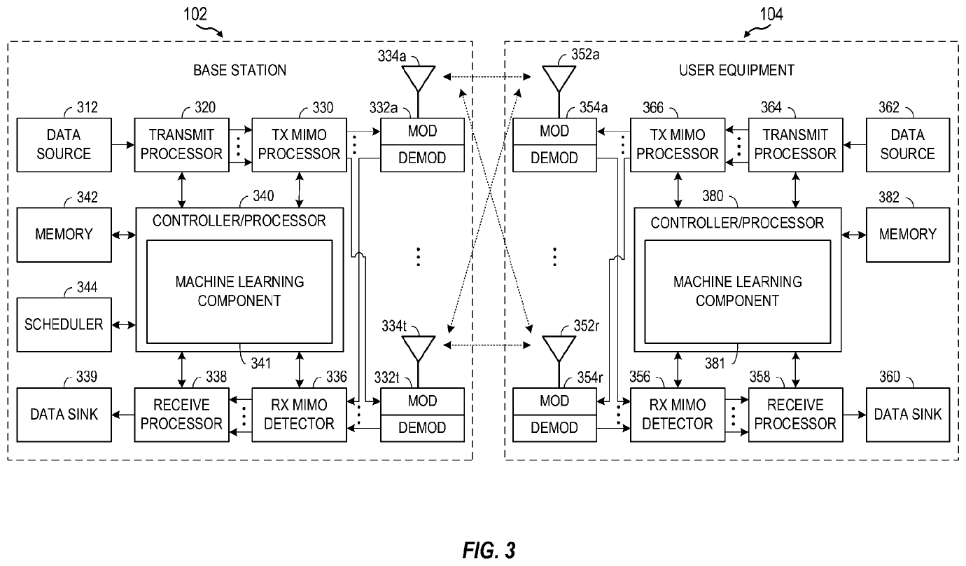

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Base station 102 includes controller/processor 340, which may be configured to implement various functions related to wireless communications. In the depicted example, controller/processor 340 includes machine learning component 241, which may be representative of the machine learning component 199 of FIG. 1. Notably, while depicted as an aspect of controller/processor 340, the machine learning component 341 may be implemented additionally or alternatively in various other aspects of base station 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

User equipment 104 includes controller/processor 380, which may be configured to implement various functions related to wireless communications. In the depicted example, controller/processor 380 includes machine learning component 381, which may be representative of the machine learning component 198 of FIG. 1. Notably, while depicted as an aspect of controller/processor 380, the machine learning component 381 may be implemented additionally or alternatively in various other aspects of user equipment 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

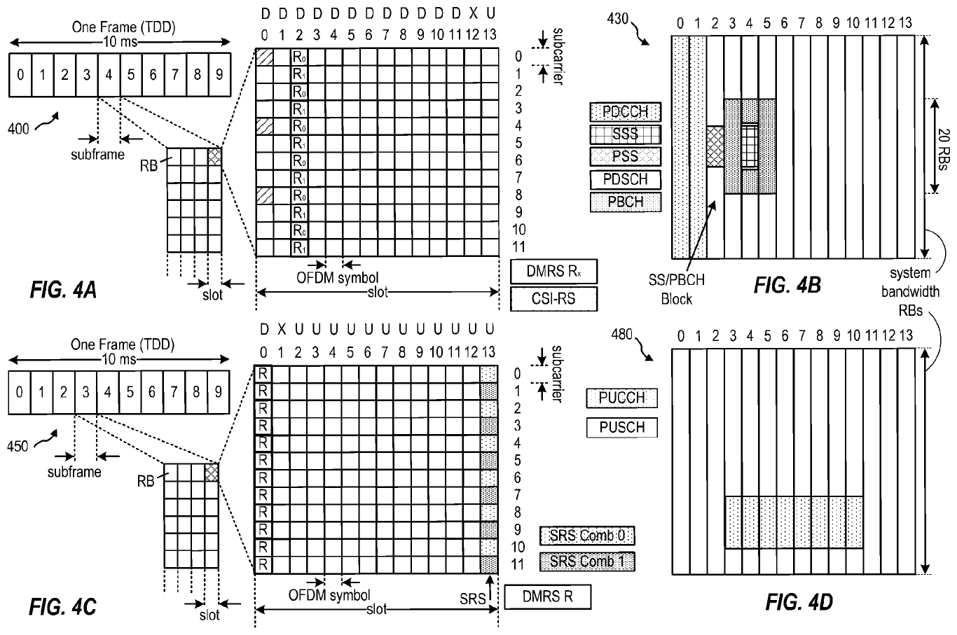

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Channel State Information

A UE may report channel state information to a radio access network. In certain cases, a CSI report configuration may indicate a codebook to use for CSI feedback. As an example, a codebook may include a precoding matrix that maps each layer (e.g., data stream) to a particular antenna port. In some cases, a codebook may include a precoding matrix that provides a linear combination of multiple input layers or beams. In certain cases, the codebook may include a set of precoding matrices, where the UE may select one of the precoding matrices for channel estimation.

For artificial intelligence (AI)-based CSI feedback, the UE may use a CSI encoder to generate the CSI using a machine learning model, for example. The encoder input may include a downlink channel matrix (H), a downlink precoder (V), and/or an interference covariance matrix (Rₙₙ). A network entity (e.g., a base station) may use a decoder to convert the AI-encoded CSI into information indicative of the channel quality, such as a precoding matrix indicator (PMI) codeword. The encoder is analogous to the PMI searching algorithm, and the decoder is analogous to the PMI codebook, which is used to translate the CSI reporting bits to a PMI codeword. The decoder output may include the downlink channel matrix (H), a transmit covariance matrix, the downlink precoder(s) (V), the interference covariance matrix (Rₙₙ), the raw versus whitened downlink channel, or any combination thereof.

In certain cases, the UE may report CSI aperiodically, for example, in response to signaling from the radio access network. When aperiodic CSI reports are triggered by the PDCCH, the UE may use certain computational resources to determine the CSI, and the UE may use a certain amount of time to perform the computation. In certain aspects, timing constraints may be used for aperiodic CSI reporting.

### Example Framework for AI/ML in a Radio Access Network

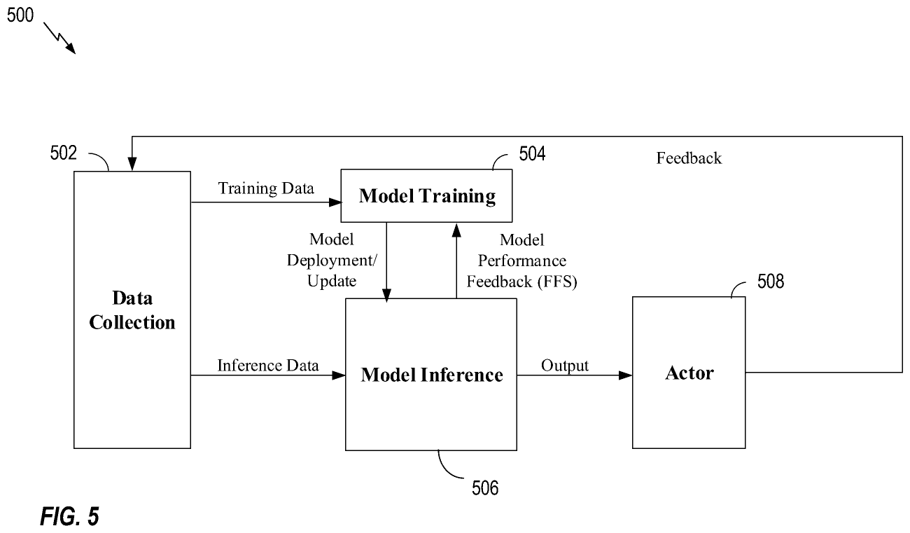

FIG. 5 depicts an example of AI/ML functional framework 500 for RAN intelligence, in which aspects described herein may be implemented.

The AI/ML functional framework includes a data collection function 502, a model training function 504, a model inference function 506, and an actor function 508, which interoperate to provide a platform for collaboratively applying AI/ML to various procedures in RAN.

The data collection function 502 generally provides input data to the model training function 504 and the model inference function 506. AI/ML algorithm specific data preparation (e.g., data pre-processing and cleaning, formatting, and transformation) may not be carried out in the data collection function 502.

Examples of input data to the data collection function 502 (or other functions) may include measurements from UEs or different network entities, feedback from the actor function, and output from an AI/ML model. In some cases, analysis of data needed at the model training function 504 and the model inference function 506 may be performed at the data collection function 502. As illustrated, the data collection function 502 may deliver training data to the model training function 504 and inference data to the model inference function 506.

The model training function 504 may perform AI/ML model training, validation, and testing, which may generate model performance metrics as part of the model testing procedure. The model training function 504 may also be responsible for data preparation (e.g., data pre-processing and cleaning, formatting, and transformation) based on the training data delivered by the data collection function 502, if required.

The model training function 504 may provide model deployment/update data to the Model interface function 506. The model deployment/update data may be used to initially deploy a trained, validated, and tested AI/ML model to the model inference function 506 or to deliver an updated model to the model inference function 506.

As illustrated, the model inference function 506 may provide AI/ML model inference output (e.g., predictions or decisions) to the actor function 508 and may also provide model performance feedback to the model training function 504, at times. The model inference function 506 may also be responsible for data preparation (e.g., data pre-processing and cleaning, formatting, and transformation) based on inference data delivered by the data collection function 502, at times.

The inference output of the AI/ML model may be produced by the model inference function 506. Specific details of this output may be specific in terms of use cases. The model performance feedback may be used for monitoring the performance of the AI/ML model, at times. In some cases, the model performance feedback may be delivered to the model training function 504, for example, if certain information derived from the model inference function is suitable for improvement of the AI/ML model trained in the model training function 504.

The model inference function 506 may signal the outputs of the model to nodes that have requested them (e.g., via subscription), or nodes that take actions based on the output from the model inference function. An AI/ML model used in a model inference function 506 may need to be initially trained, validated, and tested by a model training function before deployment. The model training function 504 and model inference function 506 may be able to request specific information to be used to train or execute the AI/ML algorithm and to avoid reception of unnecessary information. The nature of such information may depend on the use case and on the AI/ML algorithm.

The actor function 508 may receive the output from the model inference function 506, which may trigger or perform corresponding actions. The actor function 508 may trigger actions directed to other entities or to itself. The feedback generated by the actor function 508 may provide information used to derive training data, inference data or to monitor the performance of the AI/ML Model. As noted above, input data for a data collection function 502 may include this feedback from the actor function 508. The feedback from the actor function 508 or other network entities (via Data Collection function) may also be used at the model inference function 506.

The AI/ML functional framework 500 may be deployed in various RAN intelligence-based use cases. Such use cases may include CSI feedback enhancement, enhanced beam management (BM), positioning and location (Pos-Loc) accuracy enhancement, and various other use cases.

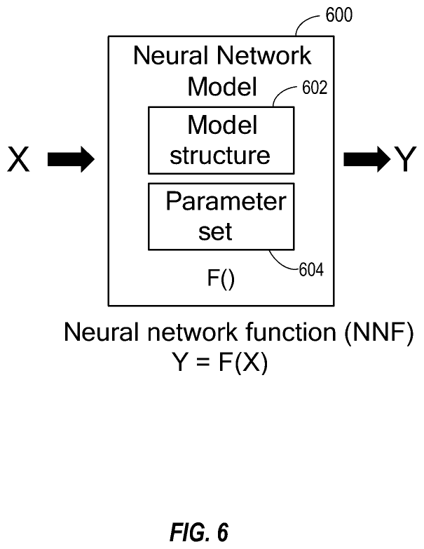

As illustrated in FIG. 6, in some cases, an ML model may be implemented as a neural network (NN) model 600 that supports at least one NN Function (NNF): Y=F(X). In some cases, each NNF may be identified by a standardized NNF ID, though non-standardized IDs may also be allowed (e.g., for private extensions). There may be standardized input X and output Y for each NNF, with mandatory information elements (IEs) for inter-vendor interworking and optional IEs for flexible implementation. One NNF may be supported by multiple NN models (e.g., for vendor specific implementations).

The NN model 600 may be defined as a model structure 602 and a parameter set 604. The model structure may be identified by a model ID (e.g., that includes a default parameter set). Each model ID may be unique in a network and may be associated with an NNF. The parameter set may include weights of the NN model and other configuration parameters. A parameter set may be location specific and/or configuration specific.

### Adaptive Learning

A non-adaptive algorithm is deterministic as a function of its inputs. If the algorithm is faced with exactly the same inputs at different times, then its outputs will be exactly the same. An adaptive algorithm (e.g., machine learning or artificial intelligence) is one that changes its behavior based on its past experience. This means that different devices using the adaptive algorithm may end up with different algorithms as time passes.

According to certain aspects, channel estimation and CSI feedback procedures may be performed using an adaptive learning-based algorithm (e.g., neural network model 600, shown in FIG. 6). Thus, over the time, the channel estimation and CSI feedback algorithm changes (e.g., adapts or updates) based on new learning. The channel estimation and CSI feedback procedures may be used for adapting various characteristics of the communication link between a UE and a network entity, such as transmit power control, modulation and coding scheme(s), code rate, subcarrier spacing, etc. For example, the adaptive learning can be used to determine a channel estimation and/or CSI feedback.

In some examples, the adaptive learning-based CSI/channel estimation involves training a model, such as a predictive model. The model may be used to determine the CSI/channel estimation associated with reference signals. The model may be trained based on training data (e.g., training information), which may include feedback, such as feedback associated with the CSI/channel estimation (e.g., measurements of reference signals).

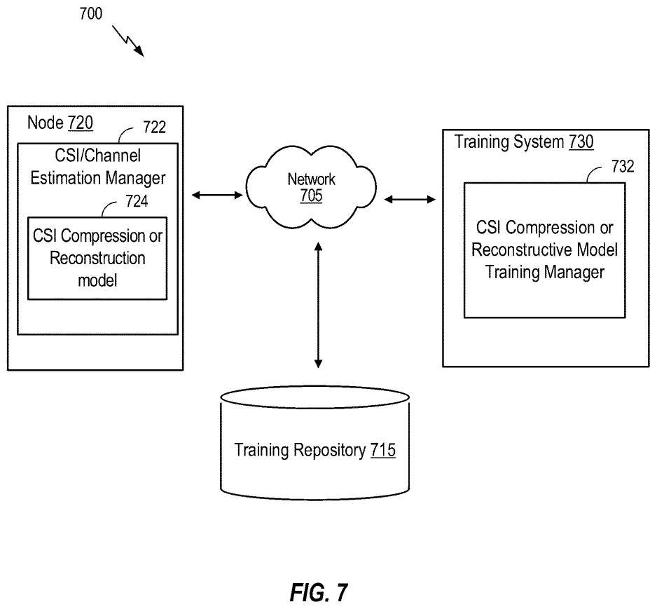

FIG. 7 illustrates an example networked environment 700 in which a CSI compression or reconstruction model 724 is used for determining CSI or channel estimation. As shown in FIG. 7, networked environment 700 includes a node 720, a training system 730, and a training repository 715, communicatively connected via network 705. The node 720 may be a UE (e.g., such as the UE 104 in the wireless communication network 100) or a BS (e.g., such as the BS 102 in the wireless communication network 100). The network 705 may be a wireless network such as the wireless communication network 100, which may be a 5G NR wireless network, for example. While the training system 730, node 720, and training repository 715 are illustrated as separate components in FIG. 7, it should be recognized by one of ordinary skill in the art that the training system 730, node 720, and training repository 715 may be implemented on any number of computing systems, either as one or more standalone systems or in a distributed environment.

The training system 730 generally includes a CSI compression or reconstruction model training manager 732 that uses training data to generate a CSI compression or reconstruction model 724 for determining CSI and/or a channel estimation based on signal measurements. The CSI compression or reconstruction model 724 may be determined based on the information in the training repository 715.

The training repository 715 may include training data obtained before and/or after deployment of the node 720. The node 720 may be trained in a simulated communication environment (e.g., in field testing, drive testing, etc.) prior to deployment of the node 720. For example, various CSI and/or channel estimations (e.g., channel quality indicator (CQI), precoding matrix indicator (PMI), reference signal received power (RSRP), a signal-to-interference plus noise ratio SINR, etc.) can be tested in various scenarios, to obtain training information related to the CSI or channel estimation procedure. This information can be stored in the training repository 715. After deployment, the training repository 715 can be updated to include feedback associated with CSI or channel estimation procedures performed by the node 720. The training repository can also be updated with information from other BSs and/or other UEs, for example, based on learned experience by those BSs and UEs, which may be associated with CSI or channel estimation procedures performed by those BSs and/or UEs.

The CSI compression or reconstruction model training manager 732 may use the information in the training repository 715 to determine the CSI compression or reconstruction model 724 (e.g., algorithm) used for CSI or channel estimation, such as to determine CQI, PMI, RSRP, SINR, etc. As discussed in more detail herein, the CSI compression or reconstruction model training manager 732 may use various different types of adaptive learning to form the CSI compression or reconstruction model 724, such as machine learning, deep learning, reinforcement learning, etc. The training system 730 may adapt (e.g., update/refine) the CSI compression or reconstruction model 724 over time. For example, as the training repository is updated with new training information (e.g., feedback), the model 724 is updated based on the new learning or experience.

The training system 730 may be located on the node 720, on a BS in the network 705, or on a different entity that determines the CSI compression or reconstruction model 724. If located on a different entity, then the CSI compression or reconstruction model 724 is provided to the node 720.

The training repository 715 may be a storage device, such as a memory. The training repository 715 may be located on the node 720, the training system 730, or another entity in the network 705. The training repository 715 may be in cloud storage, for example. The training repository 715 may receive training information from the node 720, entities in the network 705 (e.g., BSs or UEs in the network 705), the cloud, or other sources.

As described above, the node 720 is provided with (or generates, e.g., if the training system 730 is implemented in the node 720) the CSI compression or reconstruction model 724. As illustrated, the node 720 may include a CSI or channel estimation manager 722 configured to use the CSI compression or reconstruction model 724 for CSI or channel estimation described herein. In some examples, the node 720 uses the CSI compression or reconstruction model 724 to generate CSI and/or determine channel estimation based on received signal measurements. The CSI compression or reconstruction model 724 is updated as the training system 730 adapts the CSI compression or reconstruction model 724 with new learning.

Thus, the CSI or channel estimation algorithm, using the CSI compression or reconstruction model 724, of the node 720 is adaptive learning-based, as the algorithm used by the node 720 changes over time, even after deployment, based on experience/feedback the node 720 obtains in deployment scenarios (and/or with training information provided by other entities as well).

According to certain aspects, the adaptive learning may use any appropriate learning algorithm. As mentioned above, the learning algorithm may be used by a training system (e.g., such as the training system 730) to train a CSI compression or reconstruction model (e.g., such as the predictive model 724) for an adaptive-learning based CSI or channel estimation algorithm used by a device (e.g., such as the node 720) for determining CSI or channel estimation based on received signal measurements as further described herein. In some examples, the adaptive learning algorithm is an adaptive machine learning algorithm, an adaptive reinforcement learning algorithm, an adaptive deep learning algorithm, an adaptive continuous infinite learning algorithm, or an adaptive policy optimization reinforcement learning algorithm (e.g., a proximal policy optimization (PPO) algorithm, a policy gradient, a trust region policy optimization (TRPO) algorithm, or the like). In some examples, the adaptive learning algorithm is modeled as a partially observable Markov Decision Process (POMDP). In some examples, the adaptive learning algorithm is implemented by an artificial neural network (e.g., a deep Q network (DQN) including one or more deep neural networks (DNNs)).

In some examples, the adaptive learning (e.g., used by the training system 730) is performed using a neural network (e.g., the neural network 600 depicted in FIG. 6). Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

In some examples, the adaptive learning (e.g., used by the training system 730) is performed using a deep belief network (DBN). DBNs are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input could be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

In some examples, the adaptive learning (e.g., used by the training system 730) is performed using a deep convolutional network (DCN). DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods. DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

An artificial neural network, which may be composed of an interconnected group of artificial neurons (e.g., neuron models), is a computational device or represents a method performed by a computational device. These neural networks may be used for various applications and/or devices, such as Internet Protocol (IP) cameras, Internet of Things (IoT) devices, autonomous vehicles, and/or service robots. Individual nodes in the artificial neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation.” The weight values may initially be determined by an iterative flow of training data through the network (e.g., weight values are established during a training phase in which the network learns how to identify particular classes by their typical input data characteristics).

Different types of artificial neural networks can be used to implement adaptive learning (e.g., used by the training system 730), such as recurrent neural networks (RNNs), multilayer perceptron (MLP) neural networks, convolutional neural networks (CNNs), and the like. RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. Convolutional neural networks may include collections of artificial neurons that each has a receptive field (e.g., a spatially localized region of an input space) and that collectively tile an input space. Convolutional neural networks have numerous applications. In particular, CNNs have broadly been used in the area of pattern recognition and classification. In layered neural network architectures, the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

In some examples, when using an adaptive machine learning algorithm, the training system 730 generates vectors from the information in the training repository 715. In some examples, the training repository 715 stores vectors. In some examples, the vectors map one or more features to a label. For example, the features may correspond to various deployment scenario patterns discussed herein, such as frequency, subcarrier spacing, bandwidth, code rate, modulation and coding scheme, etc. The label may correspond to the CSI/channel estimation (e.g., CQI, PMI, RSRP, SINR, etc.) associated with the features for performing CSI/channel estimation. The predictive model training manager 732 may use the vectors to train the predictive model 724 for the node 720. As discussed above, the vectors may be associated with weights in the adaptive learning algorithm. As the learning algorithm adapts (e.g., updates), the weights applied to the vectors can also be changed. Thus, when the CSI/channel estimation procedure is performed again, under the same features (e.g., under the same set of conditions including frequency, subcarrier spacing, code rate, modulation and coding scheme, etc.), the model may give the node 720 a different result (e.g., different CQI, PMI, RSRP, SINR, etc.).

According to certain aspects, the adaptive learning based-CSI or channel estimation allows for continuous infinite learning. In some examples, the learning may be augmented with federated learning. For example, while some machine learning approaches use a centralized training data on a single machine or in a data center; with federated learning, the learning may be collaborative involving multiple devices to form the predictive model. With federated learning, training of the model can be done on the device, with collaborative learning from multiple devices. For example, referring back to FIG. 7, the node 720 can receive training information and/or updated trained models, from various different devices.

In certain aspects, the UE and/or the radio access network may train a set of machine learning models, where each model may be designed and/or developed for a certain scenario, such as an urban micro cell, an urban macro cell, or an indoor hotspot. The models may be associated with various bandwidth configurations. The models may be associated with various CSI payloads to fit different UE locations or wireless conditions. For example, if the UE is located near the cell center, the UE can report a CSI payload with greater resolution, and the UE may use a machine learning model associated with the particular CSI payload. If the UE is located on a cell edge, the UE may report a CSI payload with low resolution due to the cell coverage, and the UE may use a different machine learning associated with the low resolution CSI payload. In some cases, the models may be associated with various antenna architectures at the UE and/or base station. In certain aspects, the UE may use models to support beam management. For example, the UE may use a model to determine beams to use in future transmission occasions or determine finer beams based on coarse beam, and the UE may report the determined beam(s) with the RSRP associated with the beam(s) to the radio access network. In certain aspects, the UE may use models to perform positioning, where the UE may use the model to determine the distance and/or angle of the UE position relative to a base station, for example.

After training the models, the models may be registered with the radio access network. A model server (e.g., the training system 730 and/or training repository 715) may test the models, compile the models to run-time images, and store the run-time images. The model server may indicate to the radio access network to register the models. When the radio access network deploys a model, the radio access network may configure the UE to use the model (e.g., indicating a model identifier associated with the model), and the UE may download the run-time image of the model from the model server (e.g., the training repository 715). Due to different UE architectures, UEs may support storing a different number of models in their modems and/or memory (e.g., non-volatile memory and/or random access memory), and the UEs may use different amounts of time to switch to using a model stored in the modem or to switch to using a model stored in memory.

While the examples depicted in FIG. 7 are described herein with respect to AI-based CSI or channel estimation to facilitate understanding, aspects of the present disclosure may also be applied to other AI generated information, including beam management information and/or UE positioning information, for example.

### Aspects Related to Machine Learning in Wireless Communications

Aspects of the present disclosure provide apparatus and techniques for using machine learning in wireless communications. As UEs may have different architectures, machine learning capabilities may be divided into different categories or different aspects. As an example, a machine learning capability may represent the maximum number of active machine learning models that a UE is capable of processing or storing (e.g., via the UE's modem), the maximum number of inactive machine learning models that the UE is capable of storing (e.g., in memory), the minimum amount of time used to switch to using an inactive machine learning model, or combinations of machine learning models the UE is capable of processing or storing concurrently. The UE may indicate, to a radio access network, the specific machine learning capabilities that the UE is capable of performing (e.g., the maximum number of machine learning models that the UE is capable of processing or storing in its modem), and the radio access network may configure the UE with machine learning model(s) according to the machine learning capabilities. For example, if the UE can only support storing and processing a single machine learning model in its modem, the radio access network may configure or schedule the UE with processing using only a single machine learning model at any time.

Different timelines may be supported for processing CSI using machine learning models. For example, a faster timeline may be used if the UE is switching between active machine learning models (e.g., stored in the UE's modem), and a slower timeline may be used if the UE is activating a new machine learning model. To activate a new machine learning model, the UE may download the machine learning model from the radio access network or load the machine learning model from memory (e.g., non-volatile memory or random access memory).

Certain criteria for concurrent processing of machine learning models may be supported. For example, a machine learning model may occupy a number of processing units. A UE may support a maximum number of processing units associated with machine learning models, such that the UE is capable of processing multiple machine learning models concurrently up to the maximum number of processing units. In another aspect, the criteria of concurrent processing may be supported by reporting machine learning model combinations and the number of concurrent processing tasks or inference tasks associated with a combination configured/scheduled concurrently. In this case, the UE may report one or more model combinations, e.g., a first combination including {model 1, 2, 3} and second combination including {model 1 and 2}. The UE may report a total number inference tasks the combinations can process or report a number of inference tasks associated with each model in a combination. For example, the UE may report a total three tasks for the combination of {model 1 and 2} and a total of four tasks for the combination of {model 1, 2, 3}.

The machine learning model procedures described herein may enable improved wireless communication performance (e.g., higher throughputs, lower latencies, and/or spectral efficiencies). For example, different UE architectures may support different timelines for processing CSI (and/or other information) using machine learning models. The different categories for machine learning capabilities may allow the radio access network to dynamically configure a UE with machine learning models in response to the UE's particular machine learning capabilities. Such dynamic configurations may allow a UE to process CSI (and/or beam management information, UE positioning information, channel estimation, etc.) using machine learning models under various conditions, such as high latency, low latency, ultra-low latency, high resolution CSI, low resolution CSI, wide beam, narrow beam, etc.

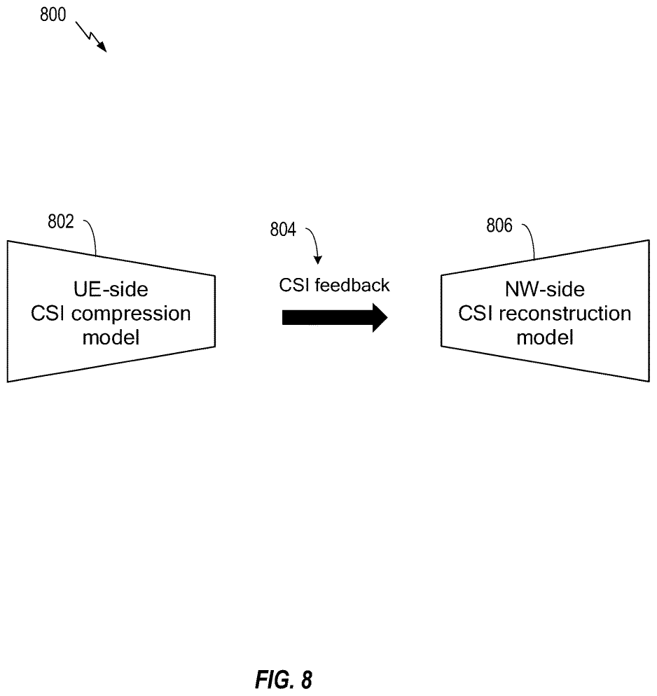

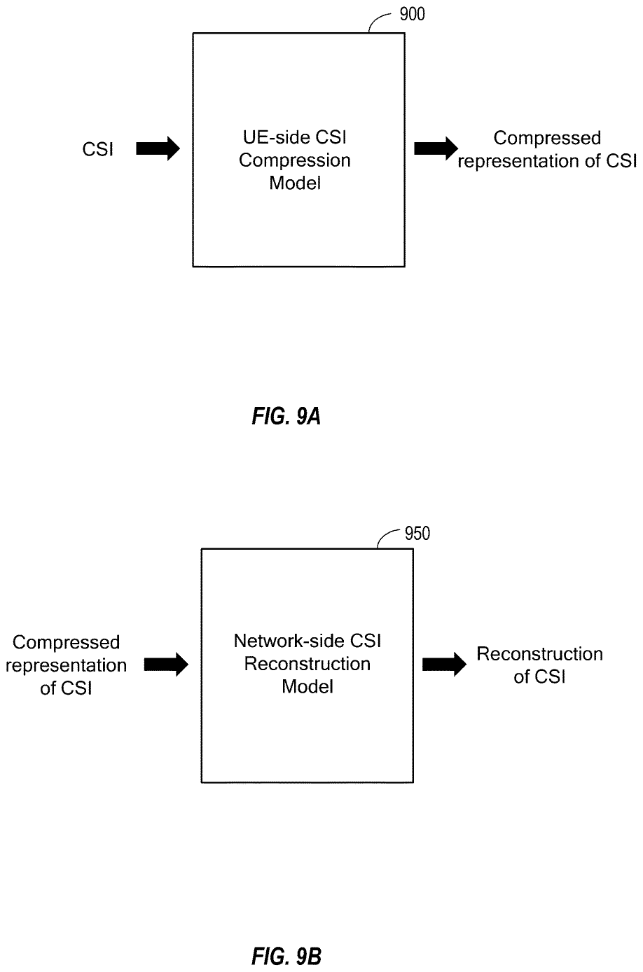

FIG. 8 depicts an example 800 of a UE and a network entity (e.g., a gNB) using trained AI/ML models to convey channel state information (CSI) from the UE to the network entity, according to aspects of the present disclosure. The UE may use a neural network, such as the example UE-side AI/ML model illustrated in FIG. 9A, to derive a compressed representation of the CSI, as illustrated at 802. At 804, the UE may send the CSI feedback to the network entity. The network entity may use another neural network, such as the example network-side AI/ML model illustrated in FIG. 9B, to reconstruct the information from the compressed representation, as illustrated at 806. The UE-side and network-side ML models are trained in a collaborative manner, so that the compressed representation created by the UE-side model is interpreted and decoded correctly by the network-side model, enabling the reconstruction to be accurate. When the UE-side and network-side models are collaboratively trained, then such a pair of models is said to be compatible to each other.

In aspects of the present disclosure, a UE and a network entity (e.g., a gNodeB (gNB)) may use a network-side ML-based model and a compatible UE-side ML-based model to collaboratively implement one or more functions of a communications system.

FIG. 9A depicts an example UE-side AI/ML model 900, in accordance with aspects of the present disclosure. The model structure may be identified by a model ID. The example UE-side AI/ML model is supplied with CSI data, and the model outputs a compressed representation of the CSI. This compressed representation may be transmitted by a UE (e.g., UE 104 depicted and described with respect to FIGS. 1 and 3.

FIG. 9B depicts an example network-side AI/ML model 950, in accordance with aspects of the present disclosure. The example network-side AI/ML model is supplied with a compressed representation of CSI that may, for example, be received in a transmission from a UE. The model outputs a reconstruction of the CSI that may, for example, be used by a network entity in determining transmission parameters for use in transmitting to a UE and in determining transmission parameters for the UE to use in transmitting to the network entity.

The data collection for training CSI compression and reconstruction models may include precoding vectors collected from various UEs under various channel conditions. One approach to collecting such data at a large scale is to use existing CSI feedback mechanisms in 5G NR communications systems. For example, the Release 16 (Rel-16) enhanced Type II CSI feedback mechanism enables a UE to report a recommended precoding vector for each spatial layer and subband.

In typical CSI feedback approaches, a UE derives coefficients based on projecting the precoding vector to a basis set. The UE then quantizes the coefficients based on configured parameters and conveys the quantized coefficients as a vector of bits in a CSI feedback message.

It is desirable for a training dataset of an ML model to capture the distribution of the data that the model will experience during an inference operation, for the ML model to perform well. That is, it is desirable to train an ML model with a training dataset that has a same data distribution as real-world data the ML model will encounter during inference operations. Any unique aspects or patterns in the training dataset that do not also appear during an inference operation by the ML model can cause sub-optimal performance. The NN training process may, for example, overfit the ML model to these patterns in the training data that the ML model does not encounter during an inference operation. For example, the quantization of the coefficients in a typical CSI feedback approach may result in a pattern in the data that may cause the NN to overfit the pattern caused by the quantization. If, for example, coefficients in a training dataset had been quantized by rounding the coefficients to a nearest quantization level, a NN trained with that training dataset might be trained to only output values corresponding to the quantization levels, because all of the data in the training dataset were values corresponding to the quantization levels.

Therefore, it is desirable to develop techniques for preparing datasets for training ML-based models so that the datasets do not have patterns that the ML model will not encounter during inference operations.

### Aspects Related to Preparing Datasets for Training Machine Learning Based Models in Wireless Communications

According to aspects of the present disclosure, a training dataset may be prepared for training a machine learning (ML) model by applying a function to entries in the training dataset. An example of such a data preparation function is dithering some or all of the entries in a training dataset, to remove a superfluous pattern in the dataset, such as may be caused by quantizing data included in the dataset. For example, each of the quantized coefficients in a CSI feedback message may be perturbed by a fixed or random amount to reduce or eliminate a pattern introduced by the quantization.

In aspects of the present disclosure, entries in a dataset may be dithered in preparation to training a ML model with the dataset.

According to aspects of the present disclosure, quantized coefficients in a CSI feedback message may be perturbed, prior to including the CSI feedback message in a training dataset, in order to reduce a pattern introduced by the quantization applied to the coefficients. A magnitude of the perturbation may be based on one or more quantization levels used when deriving the coefficients.

In aspects of the present disclosure, entries of a CSI feedback may each include an amplitude coefficient and a phase coefficient, and the perturbation applied to dither a dataset may be applied to the amplitude coefficient, the phase coefficient, or to both coefficients of one or more of the entries.

According to aspects of the present disclosure, a CSI feedback message may first be decoded into a precoding vector, and the entries of the precoding vector may then be perturbed by a random amount before the CSI feedback message is included in a dataset in order to dither the dataset. For example, in a typical Release 16 Type II CSI feedback mechanism, the precoder W is represented as:

$$W = {W}_{1} {W}_{2} {W}_{f}$$

where W₁ is a spatial domain basis and W_{f} is a frequency domain basis. The coefficients of W₂ are determined by a reporting entity (e.g., a UE) and quantized according to configured Release 16 Type II CSI feedback parameters. In aspects of the present disclosure, during dithering, the quantized version of W₂ may be perturbed, such that

$${W}_{dithered} = {W}_{1} g ( {W}_{2} ) {W}_{f}$$

where g( ) is a perturbing function. For example, for each entry ae^{jθ} in W₂, g(ae^{jθ}) may be (a+Δ₁)e^{(0+Δ2)}, where Δ₁ and Δ₂ are the amplitude and phase perturbations, respectively.

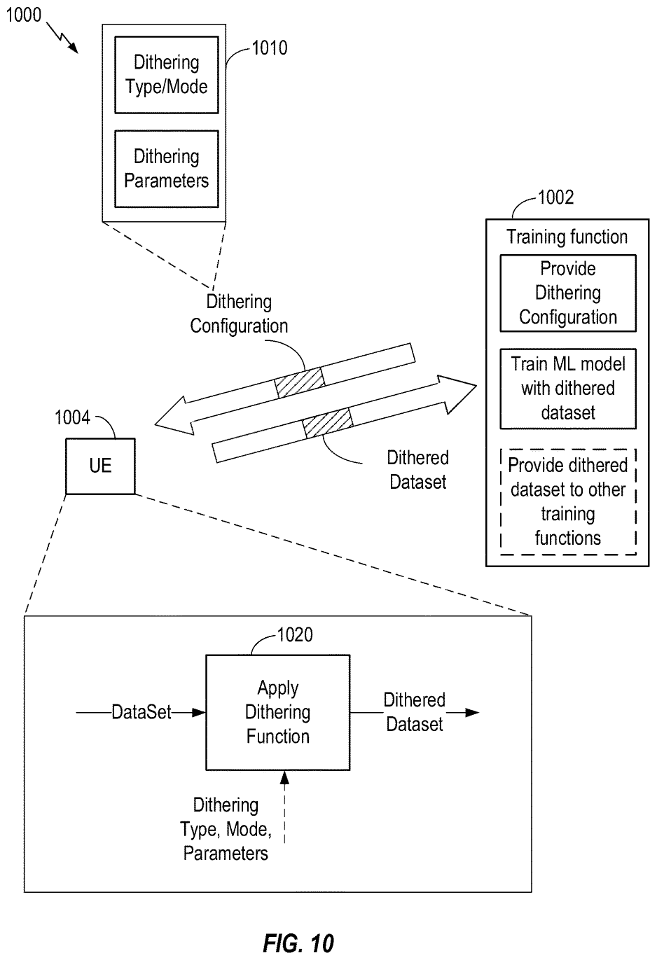

FIG. 10 depicts an example process flow 1000 of a dataset being dithered in preparation for training a ML model, in accordance with aspects of the present disclosure. In the example process flow 1000, a training function 1002 sends a dithering configuration 1010 to a UE 1004. The training function 1002 may be implemented at one or more network entities or servers that may be examples of the BS 102, shown in FIGS. 1 and 3, or another network entity. The UE 1004 may be an example of the UE 104, shown in FIGS. 1 and 3. The dithering configuration 1010 may include one or more indications of a dithering type or mode and zero or more parameters (e.g., numeric values) that may be used in a dithering function. As illustrated, the UE 1004 may obtain a dataset (e.g., CSI coefficients), apply a dithering function 1020 to entries of the dataset to generate a dithered dataset, and transmit the dithered dataset to the training function 1002. Also as illustrated, the training function may provide the dithering configuration 1010, train a ML model with the dithered dataset, and optionally provide the dithered dataset to other training functions.

While the example process flow 1000 is described as using a dithering function, the present disclosure is not so limited, and other data preparation functions may be applied to a dataset. Similarly, while the example process flow 1000 shows the UE 1004 receiving a dithering configuration 1010 from training function 1002 and transmitting a dithered dataset to the same training function 1002, the present disclosure is not so limited, and any node may obtain a data preparation configuration from a training function, apply a data preparation function to a dataset, and provide the prepared dataset to a different training function or the same training function, as described herein.

According to some aspects of the present disclosure, the dithered dataset may be collected by a data collection entity, which may provide the dithered dataset to one or more training functions implemented on one or more servers or network entities.

In aspects of the present disclosure, a UE before may perform a data preparation operation (e.g., dithering) before the UE stores the data or sends the data to a data collection entity.

According to aspects of the present disclosure, the network (e.g., a network entity) may configure a UE with a data preparation type or mode and associated parameters. The UE may then perform the quantization and dithering as configured by the network. The UE may then either store the data sample locally or transmit the data sample to a gNB, a data collection entity, or a training entity.

In aspects of the present disclosure, the network configuring a UE with a data preparation type or mode and parameters may ensure that different UEs apply similar processing to data to ensure uniformity in the distribution of data collected from the different UEs and included in a training dataset.

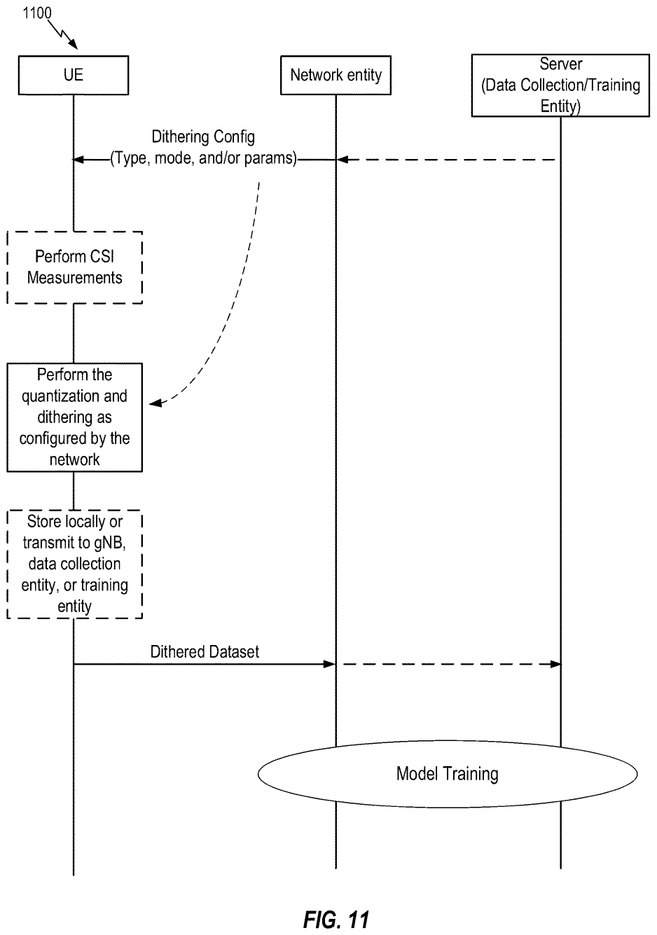

FIG. 11 is a signaling flow illustrating an example 1100 of a UE performing a dithering operation on quantized CSI feedback coefficients to create a dithered dataset prior to storing the dithered dataset or providing the dithered dataset to a network entity (e.g., a gNB), data collection entity, or training entity. As illustrated, the UE obtains a dithering configuration from the network entity. Optionally, the UE may obtain the dithering configuration from the data collection entity or training entity via the network entity. The UE performs CSI measurements, then quantizes the coefficients of the CSI feedback and dithers the coefficients according to the dithering configuration. The UE then optionally stores the dithered dataset or transmits the dithered dataset to the network entity, data collection entity, or training entity.

According to aspects of the present disclosure, a data preparation operation (e.g., dithering) may be performed by a network entity (e.g., a gNB) upon obtaining (e.g., receiving) a dataset (e.g., CSI feedback).

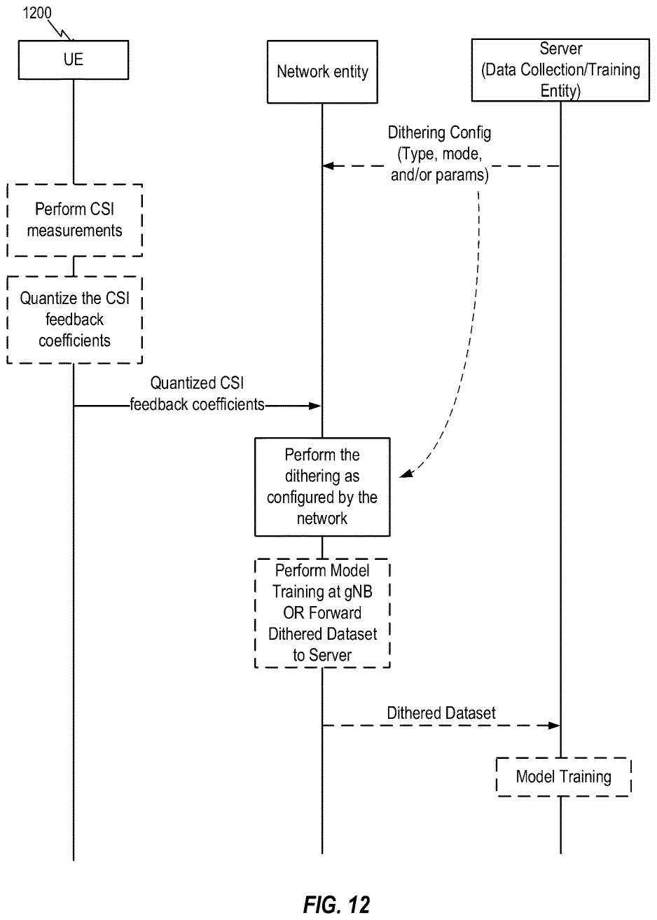

FIG. 12 is a signaling flow illustrating an example 1200 of a network entity (e.g., a gNB) performing a dithering operation on quantized CSI feedback coefficients to create a dithered dataset prior to performing model training or providing the dithered dataset to a data collection entity or training entity. As illustrated, the network entity may obtain a dithering configuration from a data collection entity or training entity. As illustrated, the network entity obtains quantized CSI feedback coefficients from a UE, then dithers the quantized CSI feedback coefficients according to the dithering configuration. The network entity then optionally performs model training with the dithered dataset or transmits the dithered dataset to the data collection entity or training entity.

In aspects of the present disclosure, a data collection entity (e.g., server) may perform a data preparation operation (e.g., dithering) upon obtaining (e.g., collecting from) a dataset (e.g., CSI data samples) from UEs or BSs (e.g., gNBs).

According to aspects of the present disclosure, a training entity (e.g., server), may perform a data preparation operation (e.g., dithering) during a training process of a ML model.

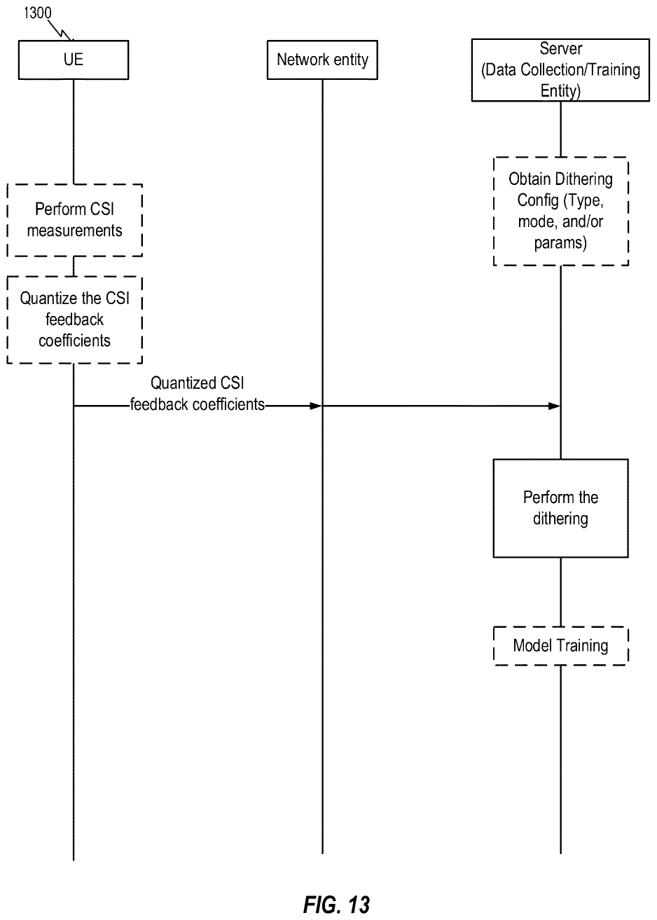

FIG. 13 is a signaling flow illustrating an example 1300 of a server (e.g., a data collection entity or a training entity) performing a dithering operation on quantized CSI feedback coefficients to create a dithered dataset prior to performing model training. As illustrated, the server may obtain (e.g., from another server or network controller) a dithering configuration. As illustrated, the server obtains quantized CSI feedback coefficients from a UE, optionally via a network entity (e.g., a gNB). The server then dithers the quantized CSI feedback coefficients according to the dithering configuration. The server then optionally performs model training with the dithered dataset or transmits the dithered dataset to another data collection entity or training entity.

In some cases, it may be desirable to transfer a training dataset between the UE-side and network-side. For example, data collected by a UE may be sent to a network-side training server. In another example, a network-side training server may share a dataset with a UE-side training server to assist in sequential training of the UE-side model. In still another example, data collected at the network-side may be sent to a UE for fine tuning a UE-side model.

In all of these cases, it is desirable to indicate whether the dataset has already been subject to a data preparation function (e.g., dithering) together with the dataset. In such cases, it may also be desirable to indicate details (e.g., type, mode, and/or parameters, such as fixed or random perturbation, magnitude of perturbation, variance of random perturbation, and/or other statistics associated with the amount of the perturbation applied) regarding the data preparation that was performed.

According to aspects of the present disclosure, a node (e.g., a network-side training server) may transfer a dataset (e.g., a training dataset) to another node (e.g., a UE-side training server) and provide an indication with the dataset that a data preparation function (e.g., a dithering function) has been applied to the dataset. The other node may then train a ML model with the dataset.

In aspects of the present disclosure, a node transferring a dataset to another node may indicate details (e.g., type or mode and parameters of) regarding a data preparation function that was applied to the dataset prior to the transfer.

According to aspects of the present disclosure, an indication of details regarding a data preparation function may be made using radio resource control (RRC) signaling or using user plane messages.

According to aspects of the present disclosure, a node (e.g., a network-side training server) may transfer a dataset (e.g., a training dataset) to another node (e.g., a UE-side training server) and provide an indication with the dataset that a data preparation function (e.g., a dithering function) has not been applied to the dataset. The other node may then optionally apply a data preparation function to the dataset and train a ML model with the dataset.

### Example Operations

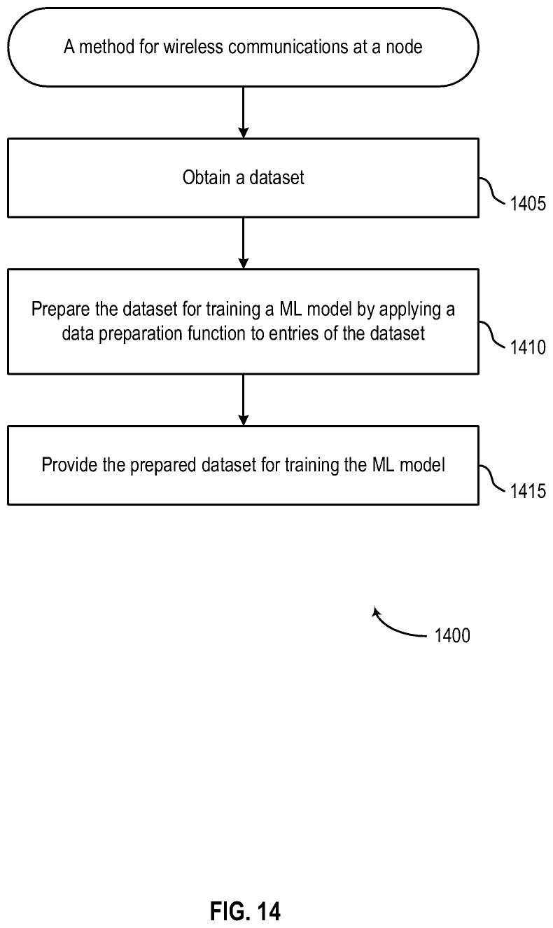

FIG. 14 shows an example of a method 1400 of wireless communications at a node. In some examples, the node is a user equipment, such as a UE 104 of FIGS. 1 and 3. In some examples, the node is a network entity, such as a BS 102 of FIGS. 1 and 3, or a disaggregated base station as discussed with respect to FIG. 2.

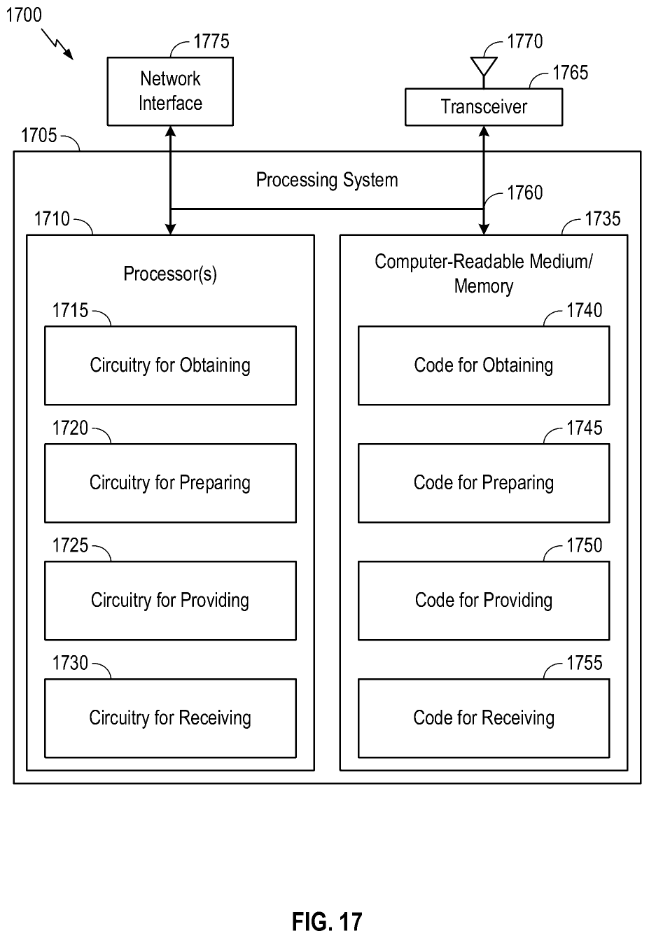

Method 1400 begins at operation 1405 with obtaining a dataset. In some cases, the operations of this step refer to, or may be performed by, circuitry for obtaining and/or code for obtaining as described with reference to FIG. 17.

Method 1400 then proceeds to operation 1410 with preparing the dataset for training a ML model by applying a data preparation function to entries of the dataset. In some cases, this operation refers to, or may be performed by, circuitry for preparing and/or code for preparing as described with reference to FIG. 17.

Method 1400 then proceeds to operation 1415 with providing the prepared dataset for training the ML model. In some cases, this operation refers to, or may be performed by, circuitry for providing and/or code for providing as described with reference to FIG. 17.

In some aspects, the entries of the dataset comprise quantized coefficients; and applying the data preparation function to the entries comprises applying a dithering function to the quantized coefficients.

In some aspects, the quantized coefficients comprise quantized coefficients for CSI feedback.

In some aspects, applying the dithering function comprises perturbing the quantized coefficients.

In some aspects, the perturbing comprises perturbing the quantized coefficients based on a fixed amount.

In some aspects, the perturbing comprises perturbing the quantized coefficients based on a random amount.

In some aspects, a magnitude of the perturbing is based on one or more quantization levels used when deriving the quantized coefficients.

In some aspects, each entry in the dataset has an amplitude coefficient and a phase coefficient; and perturbing the quantized coefficients comprises perturbing at least one of the amplitude coefficient or the phase coefficient for at least one of the entries in the dataset.

In some aspects, obtaining the dataset comprises decoding a CSI feedback message to obtain entries of a precoding vector; and preparing the dataset for training the ML model comprises perturbing the entries of the precoding vector.

In some aspects, the node comprises a network entity.

In some aspects, the dithering function is applied after receiving the dataset as CSI feedback.

In some aspects, the node comprises a data collection entity.

In some aspects, the dithering function is applied after collecting CSI data samples from one or more UEs.

In some aspects, the dithering function is applied after collecting CSI data samples from one or more network entities.

In some aspects, the node comprises a training entity; and the dithering function is applied as part of a training process.

In some aspects, the node comprises a UE.

In some aspects, the method 1400 further includes receiving signaling configuring the UE with one or more parameters for applying the data preparation function. In some cases, this operation refers to, or may be performed by, circuitry for receiving and/or code for receiving as described with reference to FIG. 17.

In some aspects, the method 1400 further includes providing an indication that the data preparation function has been applied to the entries of the dataset. In some cases, this operation refers to, or may be performed by, circuitry for providing and/or code for providing as described with reference to FIG. 17.

In some aspects, the method 1400 further includes providing one or more parameters of the data preparation function. In some cases, this operation refers to, or may be performed by, circuitry for providing and/or code for providing as described with reference to FIG. 17.

In one aspect, method 1400, or any aspect related to it, may be performed by an apparatus, such as communications device 1700 of FIG. 17, which includes various components operable, configured, or adapted to perform the method 1400. Communications device 1700 is described below in further detail.

Note that FIG. 14 is just one example of a method, and other methods including fewer, additional, or alternative operations are possible consistent with this disclosure.

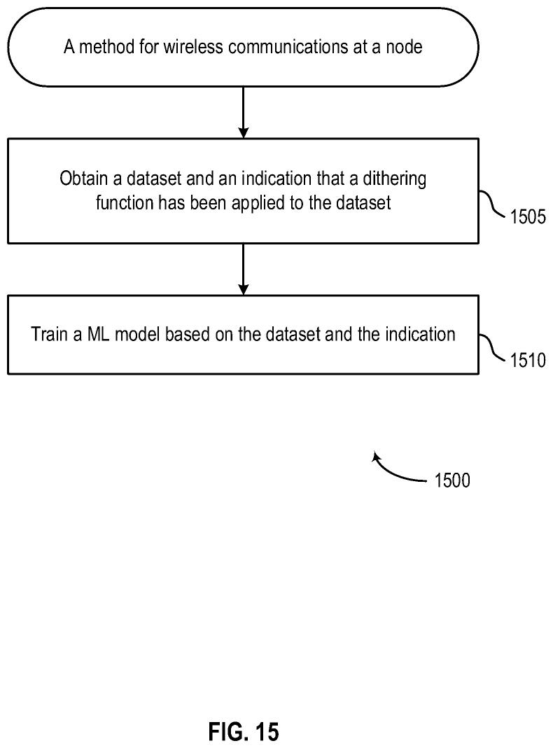

FIG. 15 shows an example of a method 1500 of wireless communications at a node. In some examples, the node is a user equipment, such as a UE 104 of FIGS. 1 and 3. In some examples, the node is a network entity, such as a BS 102 of FIGS. 1 and 3, or a disaggregated base station as discussed with respect to FIG. 2.

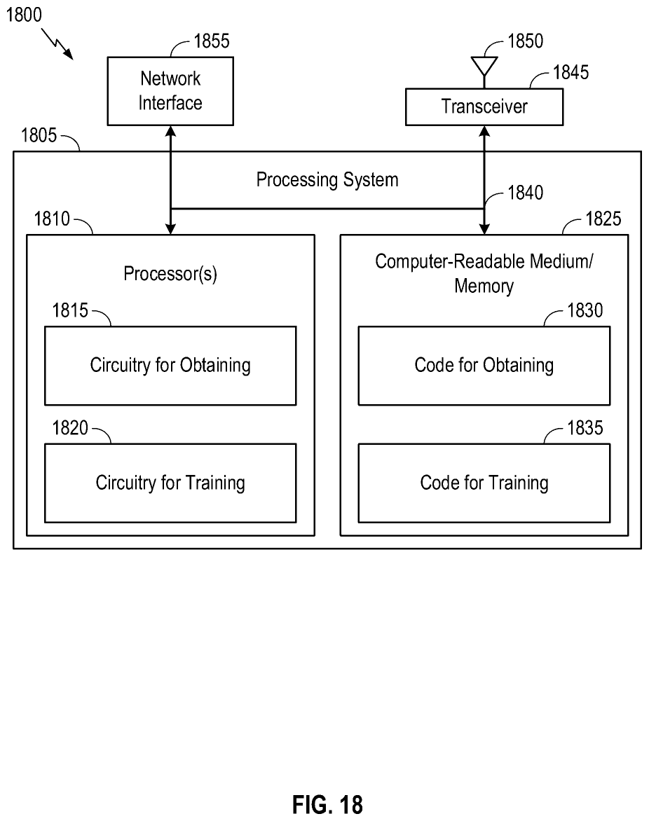

Method 1500 begins at operation 1505 with obtaining a dataset and an indication that a dithering function has been applied to the dataset. In some cases, this operation refers to, or may be performed by, circuitry for obtaining and/or code for obtaining as described with reference to FIG. 18.

Method 1500 then proceeds to operation 1510 with training a ML model based on the dataset and the indication. In some cases, this operation refers to, or may be performed by, circuitry for training and/or code for training as described with reference to FIG. 18.

In some aspects, the method 1500 further includes obtaining information regarding the dithering function. In some cases, this operation refers to, or may be performed by, circuitry for obtaining and/or code for obtaining as described with reference to FIG. 18.

In some aspects, the information comprises an indication that the dithering function comprises applying a fixed perturbation to one or more entries of the dataset.

In some aspects, the information comprises an indication that the dithering function comprises applying one or more random perturbations to one or more entries of the dataset.

In some aspects, the information comprises a magnitude of a fixed perturbation.

In some aspects, applying the dithering function comprises applying the fixed perturbation to one or more entries of the dataset.

In some aspects, the information comprises one or more statistics associated with a set of random perturbations.

In some aspects, applying the dithering function comprises applying perturbations from the set of random perturbations to one or more entries of the dataset.

In some aspects, the indication is received via RRC signaling.

In one aspect, method 1500, or any aspect related to it, may be performed by an apparatus, such as communications device 1800 of FIG. 18, which includes various components operable, configured, or adapted to perform the method 1500. Communications device 1800 is described below in further detail.

Note that FIG. 15 is just one example of a method, and other methods including fewer, additional, or alternative operations are possible consistent with this disclosure.

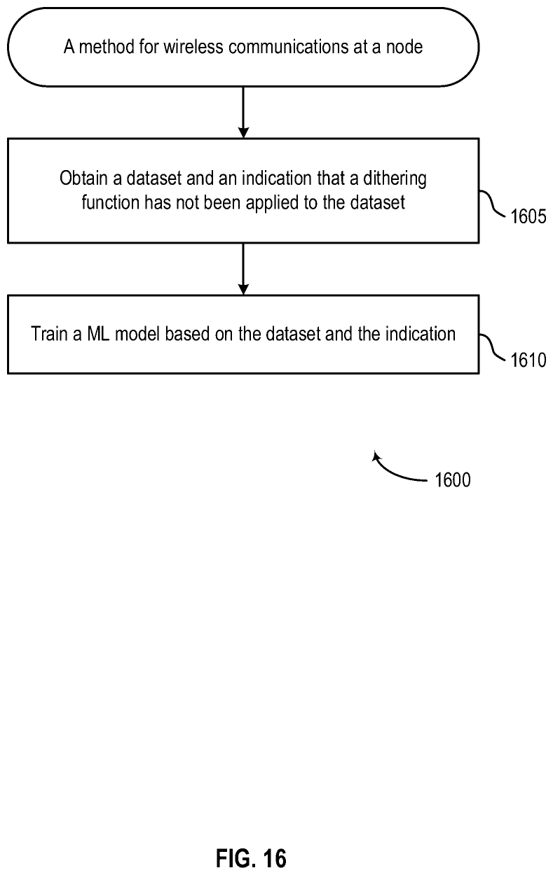

FIG. 16 shows an example of a method 1600 of wireless communications at a node. In some examples, the node is a user equipment, such as a UE 104 of FIGS. 1 and 3. In some examples, the node is a network entity, such as a BS 102 of FIGS. 1 and 3, or a disaggregated base station as discussed with respect to FIG. 2.

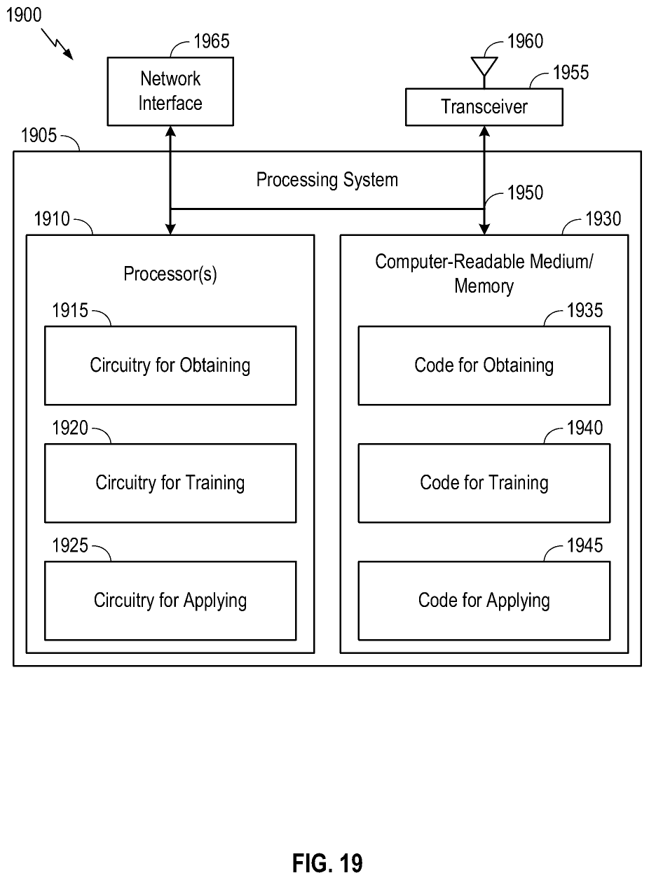

Method 1600 begins at operation 1605 with obtaining a dataset and an indication that a dithering function has not been applied to the dataset. In some cases, this operation refers to, or may be performed by, circuitry for obtaining and/or code for obtaining as described with reference to FIG. 19.

Method 1600 then proceeds to operation 1610 with training a ML model based on the dataset and the indication. In some cases, this operation refers to, or may be performed by, circuitry for training and/or code for training as described with reference to FIG. 19.

In some aspects, the method 1600 further includes applying the dithering function to the dataset prior to the training. In some cases, this operation refers to, or may be performed by, circuitry for applying and/or code for applying as described with reference to FIG. 19.

In some aspects, the indication is received via RRC signaling.

In one aspect, method 1600, or any aspect related to it, may be performed by an apparatus, such as communications device 1900 of FIG. 19, which includes various components operable, configured, or adapted to perform the method 1600. Communications device 1900 is described below in further detail.

Note that FIG. 16 is just one example of a method, and other methods including fewer, additional, or alternative operations are possible consistent with this disclosure.

### Example Communications Devices

FIG. 17 depicts aspects of an example communications device 1700. In some aspects, communications device 1700 is a user equipment, such as UE 104 described above with respect to FIGS. 1 and 3. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1765 (e.g., a transmitter and/or a receiver). In some aspects (e.g., when communications device 1700 is a network entity), processing system 1705 may be coupled to a network interface 1775 that is configured to obtain and send signals for the communications device 1700 via communication link(s), such as a backhaul link, midhaul link, and/or fronthaul link as described herein, such as with respect to FIG. 2. The transceiver 1765 is configured to transmit and receive signals for the communications device 1700 via the antenna 1770, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1735 via a bus 1760. In certain aspects, the computer-readable medium/memory 1735 is configured to store instructions (e.g., computer-executable code) that when executed by the one or more processors 1710, cause the one or more processors 1710 to perform the method 1400 described with respect to FIG. 14, or any aspect related to it. Note that reference to a processor performing a function of communications device 1700 may include one or more processors 1710 performing that function of communications device 1700.

In the depicted example, computer-readable medium/memory 1735 stores code (e.g., executable instructions), such as code for obtaining 1740, code for preparing 1745, code for providing 1750, and code for receiving 1755. Processing of the code for obtaining 1740, code for preparing 1745, code for providing 1750, and code for receiving 1755 may cause the communications device 1700 to perform the method 1400 described with respect to FIG. 14, or any aspect related to it.

The one or more processors 1710 include circuitry configured to implement (e.g., execute) the code stored in the computer-readable medium/memory 1735, including circuitry for obtaining 1715, circuitry for preparing 1720, circuitry for providing 1725, and circuitry for receiving 1730. Processing with circuitry for obtaining 1715, circuitry for preparing 1720, circuitry for providing 1725, and circuitry for receiving 1730 may cause the communications device 1700 to perform the method 1400 described with respect to FIG. 14, or any aspect related to it.

Various components of the communications device 1700 may provide means for performing the method 1400 described with respect to FIG. 14, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1765 and the antenna 1770 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1765 and the antenna 1770 of the communications device 1700 in FIG. 17.

FIG. 18 depicts aspects of an example communications device 1800. In some aspects, communications device 1800 is a user equipment, such as UE 104 described above with respect to FIGS. 1 and 3. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1845 (e.g., a transmitter and/or a receiver). In some aspects (e.g., when communications device 1800 is a network entity), processing system 1805 may be coupled to a network interface 1855 that is configured to obtain and send signals for the communications device 1800 via communication link(s), such as a backhaul link, midhaul link, and/or fronthaul link as described herein, such as with respect to FIG. 2. The transceiver 1845 is configured to transmit and receive signals for the communications device 1800 via the antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 358, transmit processor 364, TX MIMO processor 366, and/or controller/processor 380, as described with respect to FIG. 3. In various aspects, one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, cause the one or more processors 1810 to perform the method 1500 described with respect to FIG. 15, or any aspect related to it. Note that reference to a processor performing a function of communications device 1800 may include one or more processors 1810 performing that function of communications device 1800.

In the depicted example, computer-readable medium/memory 1825 stores code (e.g., executable instructions), such as code for obtaining 1830 and code for training 1835. Processing of the code for obtaining 1830 and code for training 1835 may cause the communications device 1800 to perform the method 1500 described with respect to FIG. 15, or any aspect related to it.

The one or more processors 1810 include circuitry configured to implement (e.g., execute) the code stored in the computer-readable medium/memory 1825, including circuitry for obtaining 1815 and circuitry for training 1820. Processing with circuitry for obtaining 1815 and circuitry for training 1820 may cause the communications device 1800 to perform the method 1500 described with respect to FIG. 15, or any aspect related to it.

Various components of the communications device 1800 may provide means for performing the method 1500 described with respect to FIG. 15, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1845 and the antenna 1850 of the communications device 1800 in FIG. 18. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1845 and the antenna 1850 of the communications device 1800 in FIG. 18.

FIG. 19 depicts aspects of an example communications device 1900. In some aspects, communications device 1900 is a user equipment, such as UE 104 described above with respect to FIGS. 1 and 3. In some aspects, communications device 1900 is a network entity, such as BS 102 of FIGS. 1 and 3, or a disaggregated base station as discussed with respect to FIG. 2.

The communications device 1900 includes a processing system 1905 coupled to the transceiver 1955 (e.g., a transmitter and/or a receiver). In some aspects (e.g., when communications device 1900 is a network entity), processing system 1905 may be coupled to a network interface 1965 that is configured to obtain and send signals for the communications device 1900 via communication link(s), such as a backhaul link, midhaul link, and/or fronthaul link as described herein, such as with respect to FIG. 2. The transceiver 1955 is configured to transmit and receive signals for the communications device 1900 via the antenna 1960, such as the various signals as described herein. The processing system 1905 may be configured to perform processing functions for the communications device 1900, including processing signals received and/or to be transmitted by the communications device 1900.

The processing system 1905 includes one or more processors 1910. In various aspects, the one or more processors 1910 may be representative of one or more of receive processor 358, transmit processor 364, TX MIMO processor 366, and/or controller/processor 380, as described with respect to FIG. 3. In various aspects, one or more processors 1910 may be representative of one or more of receive processor 338, transmit processor 320, TX MIMO processor 330, and/or controller/processor 340, as described with respect to FIG. 3. The one or more processors 1910 are coupled to a computer-readable medium/memory 1930 via a bus 1950. In certain aspects, the computer-readable medium/memory 1930 is configured to store instructions (e.g., computer-executable code) that when executed by the one or more processors 1910, cause the one or more processors 1910 to perform the method 1600 described with respect to FIG. 16, or any aspect related to it. Note that reference to a processor performing a function of communications device 1900 may include one or more processors 1910 performing that function of communications device 1900.

In the depicted example, computer-readable medium/memory 1930 stores code (e.g., executable instructions), such as code for obtaining 1935, code for training 1940, and code for applying 1945. Processing of the code for obtaining 1935, code for training 1940, and code for applying 1945 may cause the communications device 1900 to perform the method 1600 described with respect to FIG. 16, or any aspect related to it.

The one or more processors 1910 include circuitry configured to implement (e.g., execute) the code stored in the computer-readable medium/memory 1930, including circuitry for obtaining 1915, circuitry for training 1920, and circuitry for applying 1925. Processing with circuitry for obtaining 1915, circuitry for training 1920, and circuitry for applying 1925 may cause the communications device 1900 to perform the method 1600 described with respect to FIG. 16, or any aspect related to it.

Various components of the communications device 1900 may provide means for performing the method 1600 described with respect to FIG. 16, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1955 and the antenna 1960 of the communications device 1900 in FIG. 19. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1955 and the antenna 1960 of the communications device 1900 in FIG. 19.

### Example Clauses

Implementation examples are described in the following numbered clauses:

Clause 1: A method for wireless communications at a node, comprising: obtaining a dataset; preparing the dataset for training a ML model by applying a data preparation function to entries of the dataset; and providing the prepared dataset for training the ML model.

Clause 2: The method of Clause 1, wherein: the entries of the dataset comprise quantized coefficients; and applying the data preparation function to the entries comprises applying a dithering function to the quantized coefficients.

Clause 3: The method of Clause 2, wherein the quantized coefficients comprise quantized coefficients for CSI feedback.

Clause 4: The method of any one of Clauses 2-3, wherein applying the dithering function comprises perturbing the quantized coefficients.

Clause 5: The method of Clause 4, wherein the perturbing comprises perturbing the quantized coefficients based on a fixed amount.

Clause 6: The method of Clause 4, wherein the perturbing comprises perturbing the quantized coefficients based on a random amount.

Clause 7: The method of Clause 4, wherein a magnitude of the perturbing is based on one or more quantization levels used when deriving the quantized coefficients.

Clause 8: The method of any one of Clauses 3-7, wherein: each entry in the dataset has an amplitude coefficient and a phase coefficient; and perturbing the quantized coefficients comprises perturbing at least one of the amplitude coefficient or the phase coefficient for at least one of the entries in the dataset.

Clause 9: The method of any one of Clauses 3-8, wherein: obtaining the dataset comprises decoding a CSI feedback message to obtain entries of a precoding vector; and preparing the dataset for training the ML model comprises perturbing the entries of the precoding vector.

Clause 10: The method of any one of Clauses 3-9, wherein the node comprises a network entity.

Clause 11: The method of any one of Clauses 3-10, wherein the dithering function is applied after receiving the dataset as CSI feedback.

Clause 12: The method of any one of Clauses 3-9, wherein the node comprises a data collection entity.

Clause 13: The method of any one of Clauses 3-12, wherein the dithering function is applied after collecting CSI data samples from one or more UEs.

Clause 14: The method of any one of Clauses 3-13, wherein the dithering function is applied after collecting CSI data samples from one or more network entities.

Clause 15: The method of any one of Clauses 3-9, wherein: the node comprises a training entity; and the dithering function is applied as part of a training process.

Clause 16: The method of any one of Clauses 1-15, wherein the node comprises a UE.

Clause 17: The method of Clause 16, further comprising: receiving signaling configuring the UE with one or more parameters for applying the data preparation function.

Clause 18: The method of any one of Clauses 1-17, further comprising providing an indication that the data preparation function has been applied to the entries of the dataset.

Clause 19: The method of Clause 18, further comprising providing one or more parameters of the data preparation function.

Clause 20: A method for wireless communications at a node, comprising: obtaining a dataset and an indication that a dithering function has been applied to the dataset; and training a ML model based on the dataset and the indication.

Clause 21: The method of Clause 20, further comprising obtaining information regarding the dithering function.

Clause 22: The method of Clause 21, wherein the information comprises an indication that the dithering function comprises applying a fixed perturbation to one or more entries of the dataset.

Clause 23: The method of Clause 21, wherein the information comprises an indication that the dithering function comprises applying one or more random perturbations to one or more entries of the dataset.

Clause 24: The method of Clause 21, wherein the information comprises a magnitude of a fixed perturbation.

Clause 25: The method of Clause 24, wherein applying the dithering function comprises applying the fixed perturbation to one or more entries of the dataset.

Clause 26: The method of Clause 21, wherein the information comprises one or more statistics associated with a set of random perturbations.

Clause 27: The method of Clause 26, wherein applying the dithering function comprises applying perturbations from the set of random perturbations to one or more entries of the dataset.

Clause 28: The method of any one of Clauses 20-27, wherein the indication is received via RRC signaling.

Clause 29: A method for wireless communications at a node, comprising: obtaining a dataset and an indication that a dithering function has not been applied to the dataset; and training a ML model based on the dataset and the indication.

Clause 30: The method of Clause 29, further comprising applying the dithering function to the dataset prior to the training.

Clause 31: The method of any one of Clauses 29 and 30, wherein the indication is received via RRC signaling.

Clause 32: An apparatus, comprising: a memory comprising executable instructions; and a processor configured to execute the executable instructions and cause the apparatus to perform a method in accordance with any one of Clauses 1-31.

Clause 33: An apparatus, comprising means for performing a method in accordance with any one of Clauses 1-31.

Clause 34: A non-transitory computer-readable medium comprising executable instructions that, when executed by a processor of an apparatus, cause the apparatus to perform a method in accordance with any one of Clauses 1-31.

Clause 35: A computer program product embodied on a computer-readable storage medium comprising code for performing a method in accordance with any one of Clauses 1-31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
a memory; and
a processor coupled to the memory, the processor being configured to:
obtain a dataset;
prepare the dataset for training a machine learning (ML) model by applying a data preparation function to entries of the dataset; and
provide the prepared dataset for training the ML model.

2. The apparatus of claim 1, wherein the entries of the dataset comprise quantized coefficients; and
wherein the processor being configured to apply the data preparation function to the entries comprises the processor being configured to apply a dithering function to the quantized coefficients.

3. The apparatus of claim 2, wherein the quantized coefficients comprise quantized coefficients for channel state information (CSI) feedback.

4. The apparatus of claim 3, wherein the processor being configured to apply the dithering function comprises the processor being configured to perturb the quantized coefficients.

5. The apparatus of claim 4, wherein the processor being configured to perturb the quantized coefficients comprises the processor being configured to perturb the quantized coefficients based on a fixed amount.

6. The apparatus of claim 4, wherein the processor being configured to perturb the quantized coefficients comprises the processor being configured to perturb the quantized coefficients based on a random amount.

7. The apparatus of claim 4, wherein the processor is configured to perturb the quantized coefficients based on a magnitude based on one or more quantization levels used when deriving the quantized coefficients.

8. The apparatus of claim 3, wherein each entry in the dataset has an amplitude coefficient and a phase coefficient; and
wherein the processor being configured to perturb the quantized coefficients comprises the processor being configured to perturb at least one of the amplitude coefficient or the phase coefficient for at least one of the entries in the dataset.

9. The apparatus of claim 3, wherein:
the processor being configured to obtain the dataset comprises the processor being configured to decode a CSI feedback message to obtain entries of a precoding vector; and
the processor being configured to prepare the dataset for training the ML model comprises the processor being configured to perturb the entries of the precoding vector.

10. The apparatus of claim 3, wherein the apparatus comprises one of a network entity or a data collection entity.

11. The apparatus of claim 3, wherein the processor is configured to apply the dithering function after the apparatus receives the dataset as CSI feedback.

12. (canceled)

13. The apparatus of claim 3, wherein the processor is configured to apply the dithering function after collecting CSI data samples from one or more user equipments (UEs).

14. The apparatus of claim 3, wherein the processor is configured to apply the dithering function after collecting CSI data samples from one or more network entities.

15. The apparatus of claim 3, further comprising:
a training entity; and
the processor is further configured to apply the dithering function as part of a training process.

16. The apparatus of claim 1, wherein the apparatus comprises a user equipment (UE).

17. The apparatus of claim 16, wherein the processor is further configured to:
receive signaling comprising one or more parameters for applying the data preparation function.

18. The apparatus of claim 1, wherein the processor is further configured to provide an indication that the data preparation function has been applied to the entries of the dataset.

19. The apparatus of claim 18, wherein the processor is further configured to provide one or more parameters of the data preparation function.

20. An apparatus for wireless communication, comprising:
a memory; and
a processor coupled to the memory, the processor being configured to:
obtain a dataset and an indication that a dithering function has been applied to the dataset; and
train a machine learning (ML) model based on the dataset and the indication.

21-27. (canceled)

28. The apparatus of claim 20, wherein the processor is configured to receive the indication via radio resource control (RRC) signaling.

29-30. (canceled)
